(19) United States
(12) Patent Application Publication
(10) Pub. No.: US 2008/0012466 A1
(43) Pub. Date: Jan. 17, 2008

(54) FIELD EMISSION DEVICE

(75) Inventors: YUAN-CHAO YANG, Beijing (CN); YANG WEI, Beijing (CN); LIANG LIU, Beijing (CN); KAI-LI JIANG, Beijing (CN); SHOU-SHAN FAN, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng,Taipei Hsien (TW)

(21) Appl. No.: 11/560,793

(22) Filed: Nov. 16, 2006

(30) Foreign Application Priority Data
Jun. 30, 2006 (CN) 200610061416.X

(51) Int. Cl. H01J 1/00; H01J 19/06

(52) U.S. Cl. 313/495; 313/311

(57) ABSTRACT

A field emission device (10) includes a sealed container (12) with a light permeable portion (120). A phosphor layer (14) and a light permeable anode (16) are coated on inside surface of the light permeable portion in succession. A cathode (18) is enclosed in the sealed container. A carbon nanotube yarn is attached to the cathode facing the light permeable portion. Before being embedded into the sealed container, the carbon nanotube yarn is processed in the following steps: providing a carbon nanotube array, drawing out at least one carbon nanotube yarn string from the carbon nanotube array, treating the at least one carbon nanotube yarn string using an organic solvent in a manner such that the at least one carbon nanotube yarn string is formed into a single strand of carbon nanotube yarn, and heating the single strand of the carbon nanotube yarn.

### CROSS REFERENCE TO RELATED APPLICATION

This application is related to commonly-assigned copending application Ser. No. ______, entitled “METHOD FOR MAKING CARBON NANOTUBE-BASED DEVICE” (attorney docket number US 9507), and Ser. No. ______, entitled “CARBON NANOTUBE YARN AND METHOD FOR MAKING THE SAME” (attorney docket number US 9508). Disclosures of the above-identified application are incorporated herein by reference.

### BACKGROUND OF THE INVENTION

1. Field of the Invention

The present invention relates to field emission devices, and more particularly to a field emission device.

2. Description of Related Art

Field emission devices are based on emission of electrons in a vacuum. Electrons are emitted from micron-sized tips in a strong electric field, and the electrons are accelerated and collide with a fluorescent material. The fluorescent material then emits visible light. Field emission devices are thin, light weight, and provide high levels of brightness.

Conventionally, a material of the tips is selected from the group consisting of molybdenum (Mo) and silicon (Si). With the development of nano-technology, carbon nanotube (CNT) is also used for the tips of the field emission devices.

Theoretically, the CNT has small diameter and big slenderness (i.e. diameter/length) ratio thus making the CNT quite a powerful field emission enhancer. However, in practice, like a flat panel display, the field emission enhancer of the entire field emission film cannot achieve the field emission enhancement of a single CNT. As a result, emission voltage of the whole system is increased, and current density is decreased. Meanwhile, the process technique became complicated, and the cost becomes relatively high.

What is needed, therefore, is a field emission device having both field emission efficiency and ease of manufacture.

### SUMMARY OF THE INVENTION

A field emission device includes a sealed container with a light permeable portion. A phosphor layer and a light permeable anode are coated on an inside surface of the light permeable portion on the other in succession. A cathode is enclosed in the sealed container. A carbon nanotube yarn is attached to the tip of the cathode and faces the light permeable portion. Before being embedded in the sealed container, the carbon nanotube yarn is preferably to be processed in the following steps: providing a carbon nanotube array, drawing out at least one carbon nanotube yarn string from the carbon nanotube array, treating the at least one carbon nanotube yarn string using an organic solvent in a manner such that the at least one carbon nanotube yarn string is formed into a single strand of carbon nanotube yarn, and heating the single strand of the carbon nanotube yarn.

### BRIEF DESCRIPTION OF THE DRAWING

Many aspects of the present field emission device can be better understood with reference to the following drawings. The components in the drawings are not necessarily drawn to scale, the emphasis instead being placed upon clearly illustrating the principles of the present field emission device. Moreover, in the drawings, like reference numerals designate corresponding parts.

FIG. 1 is a schematic, cross-sectional view of a filed emission element in accordance with a preferred embodiment.

### DETAILED DESCRIPTION OF THE INVENTION

Reference will now be made to the drawings to describe in detail the preferred embodiment of the field emission device.

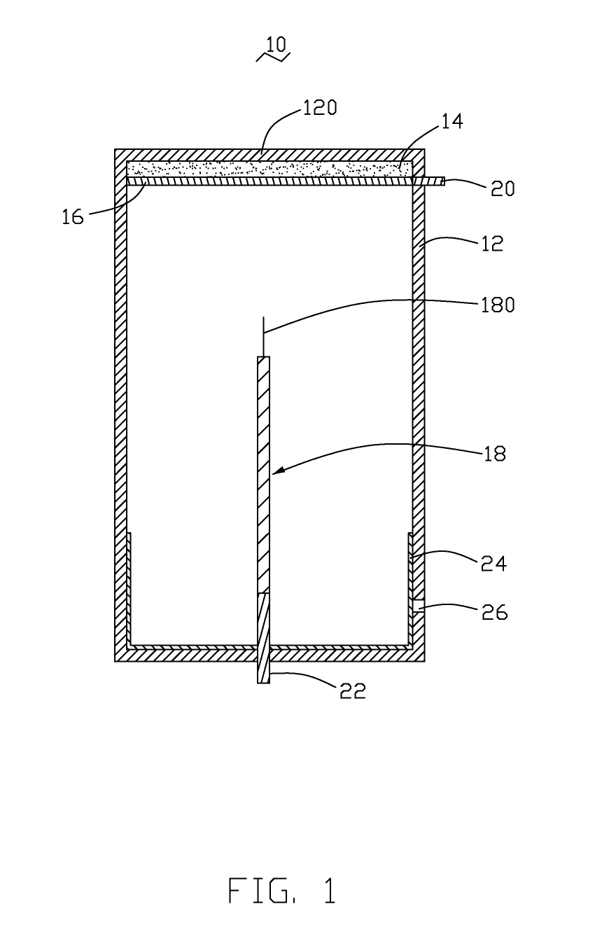

Referring to FIG. 1, a field emission device 10 includes an light permeable anode 16, a cathode 18 and a sealed container 12 enclosing the light permeable anode 16 and the cathode 18. The sealed container 12 includes a light permeable portion 120 being coated with two overlapping layers inside. A first layer is a phosphor layer 14, and a second layer is a conductive material constituting the light permeable anode 16. In other words, the phosphor layer 14 is sandwiched between the light permeable portion 120 and the light permeable anode 16. The cathode 18 is incorporated in the sealed container 12 facing the light permeable portion 120. A carbon nanotube yarn 180 is attached to the cathode 18 and faces the light permeable portion 120. The light permeable anode 16 as well as the cathode 18 is electrically connected with respective terminals for enabling application of an electric field over the cathode 18 and the light permeable anode 16. The phosphor layer 14 contains fluorescent material that can emit white or colored light when bombarded with electrons.

The sealed container 12 is a hollow member that defines an inner space, the inner space being held in vacuum. The main portion of the sealed container 12 in cross-section can be, for example, a spherical, a quadrangle, a triangle, or a polygon. In the illustrated embodiment, the main portion of the sealed container is a cylinder. The light permeable portion 120 may be a plane surface, a spherical surface, or an aspherical surface, which can be alternatively selected according to practical application within the spirit of the present invention. The sealed container 12 is light permeable, and preferably transparent. The sealed container 12 according to the embodiment is made of a nonmetal material, for example, quartz or glass. Such materials as quartz or glass are beneficial in that they are electrically insulative. The light permeable anode 16 and the terminal are electrically connected with a light permeable anode wire 20, which runs from the inside to outside of the sealed container 12. The light permeable anode 16 is a metal film with good electric conductivity. In the preferred embodiment, the light permeable anode 16 is an aluminum film.

The cathode 18 is made of one or more conductive metal material, for example, gold, copper, silver, or their alloys. Gold, copper, and silver are all noble metals, and such metals are known for their excellent conductivity (i.e., both thermal and electrical) and oxidation resistance. In the illustrated embodiment, the cathode is made of copper. Correspondingly the cathode 18 and the terminal are electrically connected with a cathode wire 22, which runs from the inside to outside of the sealed container 12.

The length of the CNT yarn 180 is in an approximate range from about 0.1 mm to about 10 mm. The diameter of the CNT yarn 180 is in an approximate range from about 1 μm to about 1 mm. Before being embedded into the sealed container 12, the CNT yarn 180 is preferably to be processed by following steps: providing a CNT array, drawing out at least one CNT yarn string from the CNT array, treating the at least one CNT yarn string using an organic solvent in a manner such that the at least one CNT yarn string is formed into a single strand of CNT yarn, and heating the single strand of the CNT yarn.

The CNT yarn is soaked in an organic solvent. Since the untreated CNT yarn is composed of a plurality of bundles of CNTs, the untreated CNT yarn has a high surface area to volume ratio and thus may easily become stuck to other objects. During the surface treatment, the CNT yarn is shrunk due to factors such as surface tension. The surface area to volume ratio and diameter of the treated CNT yarn is reduced. Accordingly, the stickiness of the CNT yarn is lowered or eliminated, and strength and toughness of the CNT yarn is improved. The organic solvent may be a volatilizable organic solvent, such as ethanol, methanol, acetone, dichloroethane, chloroform, and any combination thereof.

The preformed CNT yarn is heated to enable the CNT yarn to memorize the predetermined shape. The preformed CNT yarn should be heated at a predetermined temperature for a certain period of time sufficient to memorize the predetermined shape (i.e., re-arrange its structure in such a way that it will return to that shape after being bent). The predetermined temperature is advantageously in an approximate range from 600 to 2000 degrees centigrade and, more preferably should be in an approximate range from 1600 to 1700 degrees centigrade. For example, the preformed CNT yarn may be heated by flowing an electric current therethrough, i.e., by applying a direct current to the preformed CNT yarn for approximately 1˜4 hours to enable the CNT yarn to memorize the predetermined shape. Generally, the period of time in which an electric current heats the preformed CNT yarn should beneficially be less than 4 hours in order to avoid defects occurring in the CNT yarn and a significant loss of carbon from the CNT yarn. Alternatively, the preformed CNT yarn may be heated in a vacuum chamber, such as a graphite furnace, for about 0.5 to 1 hour to form the CNT-based device with the predetermined shape. It should be noted that, since the graphite furnace itself contains carbon, the loss of carbon from the CNT yarn is avoided even when the heating of the preformed CNT yarn lasts for a relatively long time. In addition, longer heating treatment in the graphite furnace may advantageously compensate for some defects in the CNT yarns of the CNT-based device.

After the heating treatment, the adjacent CNT segments of the CNT yarns are firmly bonded together, and a mechanical strength thereof is accordingly improved.

Preferably, in order to maintain the vacuum of the inner space of the sealed container 12, a getter 24 may be arranged therein to absorb residual gas inside the sealed container 12. More preferably, the getter 24 is arranged on an inner surface of the sealed container 12 around the cathode 18. The getter 24 may be evaporable getter introduced using high frequency heating. The getter 24 also can be non-evaporable getter. It must be assure that the getter 24 is not arranged on the light permeable anode 16 in order to avoid short circuits between the light permeable anode and the cathode.

The container 12 further includes an air vent 26. The air vent 26 connects a vacuum pump for creating a vacuum inside the sealed container 12.

In operation, when putting a voltage over the cathode 18 and the light permeable anode 16, electrons will emanate from the CNT yarn 180. The electrons move towards and transmit through the light permeable anode 16. When the electrons hit the phosphor layer 14, visible light is emitted. Part of the light is transmitted through the light permeable portion 120, and the other part of the light is reflected by the light permeable anode 16 and spread out of the light permeable portion 120. A plurality of such sealed containers 10 can be arranged together to use for lighting and display. Because using the CNT yarn, the luminance of the field emission device is enhanced while using a relatively low voltage.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. A field emission device, comprising:
a sealed container having a light permeable portion;
a phosphor layer formed on the light permeable portion in the sealed container;
a light permeable anode arranged on the phosphor layer;
a cathode facing the light permeable anode; and
a carbon nanotube yarn attached to the cathode, wherein the carbon nanotube yarn is obtained by a method comprising the steps of providing a carbon nanotube array, drawing out at least one carbon nanotube yarn string from the carbon nanotube array, treating the at least one carbon nanotube yarn string using an organic solvent in a manner such that the at least one carbon nanotube yarn string is formed into a single strand of carbon nanotube yarn, and heating the single strand of the carbon nanotube yarn.

2. The field emission device as described in claim 1, wherein a vacuum is formed inside the sealed container.

3. The field emission device as described in claim 1, wherein the sealed container is a hollow cylinder.

4. The field emission device as described in claim 1, wherein the sealed container is comprised of a material selected from the group consisting of quartz, glass and any combination thereof.

5. The field emission device as described in claim 1, wherein the light permeable portion can be selected from the group consisting of plane surfaces, a spherical surfaces, and aspherical surfaces.

6. The field emission device as described in claim 1, wherein the cathode comprises a metal material selected from the group consisting of gold, copper, silver, and any alloy thereof.

7. The field emission device as described in claim 1, wherein a length of the carbon nanotube yarn is in an approximate range from about 0.1 mm to about 10 mm.

8. The field emission device as described in claim 1, wherein a diameter of the carbon nanotube yarn is in an approximate range from about 1 μm to about 1 mm.

9. The field emission device as described in claim 1, wherein the organic solvent is a volatilizable organic solvent.

10. The field emission device as described in claim 10, wherein the volatilizable organic solvent is selected from a group consisting of ethanol, methanol, acetone, dichloroethane, chloroform and any combination thereof.

11. The field emission device as described in claim 1, wherein the single strand of the carbon nanotube yarn is heated in a vacuum chamber.

12. The field emission device as described in claim 12, wherein the single strand of the carbon nanotube yarn is heated in a graphite furnace.

13. The field emission device as described in claim 1, wherein the single strand of the carbon nanotube yarn is heated by flowing an electric current therethrough.

14. The field emission device as described in claim 14, wherein the single strand of the carbon nanotube yarn is heated for a time period of less than four hours.

15. The field emission device as described in claim 1, wherein the single strand of the carbon nanotube yarn is heated at a temperature in an approximate range from 600 to 2000 degrees centigrade.

16. The field emission device as described in claim 16, wherein the single strand of the carbon nanotube yarn is heated at a temperature in an approximate range from 1600 to 1700 degrees centigrade.

17. The field emission device as described in claim 1, wherein the light permeable anode is an aluminum film.
